(19) United States
(12) Patent Application Publication
(10) Pub. No.: US 2012/0033141 A1
(43) Pub. Date: Feb. 9, 2012

(54) TELEVISION AND ELECTRONIC DEVICE

(75) Inventor: Kenji Nonaka, Kumagaya-shi (JP)

(73) Assignee: KABUSHIKI KAISHA TOSHIBA, Tokyo (JP)

(21) Appl. No.: 13/152,992

(22) Filed: Jun. 3, 2011

(30) Foreign Application Priority Data
Aug. 5, 2010 (JP) 2010-176651

(51) Int. Cl. H04N 5/64

(52) U.S. Cl. 348/836; 348/E05.128

(57) ABSTRACT

According to one embodiment, a television includes a display panel, a flat plate-shaped cover further includes a margin portion around four sides of the cover, such as to extrude outward from the display panel, a pin extending from the margin portion in a direction crossing the cover and includes a groove portion, and a first metal fitting further includes an opening portion includes a first part and a second part, and a fitting main body which defines surroundings of the opening portion, the display panel being interposed between the cover and the first metal fitting. The first metal fitting is movable between a first position where the pin is put into the first part and a second position where the pin is put into the second part.

### CROSS-REFERENCE TO RELATED APPLICATIONS

This application is based upon and claims the benefit of priority from Japanese Patent Application No. 2010-176651, filed Aug. 5, 2010, the entire contents of which are incorporated herein by reference.

### FIELD

Embodiments described herein relate generally to a thin-profile television comprising a display panel.

### BACKGROUND

In many cases, electronic devices such as television and mobile phones employ transparent covers to surround their display portions. For attaching such a cover to the housing, it is popular to use double-sided adhesive tapes.

However, when a double-sided tape is employed for the attachment of the cover as described above, there may be an inconvenience as follows. That is, when some trouble occurs and when the device is disassembled for repair, the attached cover may be deformed or stained during the repair and it may become necessary to replace the cover.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of a television, which is an example of the electronic device according to this embodiment;

FIG. 2 is an exemplary exploded perspective view of the television shown in FIG. 1;

FIG. 3 is an exemplary perspective view of a first metal fitting of the television shown in FIG. 2;

FIG. 4 is an exemplary top view of the first metal fitting shown in FIG. 3;

FIG. 5 is an exemplary side view of the first metal fitting shown in FIG. 3;

FIG. 6 is an exemplary perspective view of a pin of a second metal fitting shown in FIG. 1;

FIG. 7 is an exemplary top view showing a slit made in a flange portion of the second metal fitting shown in FIG. 6;

FIG. 8 is an exemplary side view schematically showing an assembling process of the television shown in FIG. 2;

FIG. 9 is an exemplary perspective view showing the state where the first metal fitting shown in FIG. 3 is at a first position;

FIG. 10 is an exemplary perspective view showing the state where the first metal fitting shown in FIG. 3 is at a second position;

FIG. 11 is an exemplary side view showing the state where the first metal fitting shown in FIG. 5 is at a first position;

FIG. 12 is an exemplary side view showing the state where the first metal fitting shown in FIG. 5 is at a second position, and a protruding portion of the first metal fitting is fit into a recess portion of a frame member; and

FIG. 13 is an exemplary top view showing a modified example of the second metal fitting shown in FIG. 7.

### DETAILED DESCRIPTION

Various embodiments will be described hereinafter with reference to the accompanying drawings.

In general, according to one embodiment, a television includes a display panel; a flat plate-shaped cover further comprising a margin portion around four sides of the cover, such as to extrude outward from the display panel; a pin extending from the margin portion in a direction crossing the cover and comprising a groove portion; and a first metal fitting further comprising an opening portion comprising a first part having a diameter larger than a diameter of the pin and a second part formed continuous to the first part and having a diameter smaller than the diameter of the pin, and a fitting main body which defines surroundings of the opening portion, the display panel being interposed between the cover and the first metal fitting. The first metal fitting is movable between a first position where the pin is put into the first part and a second position where the pin is put into the second part.

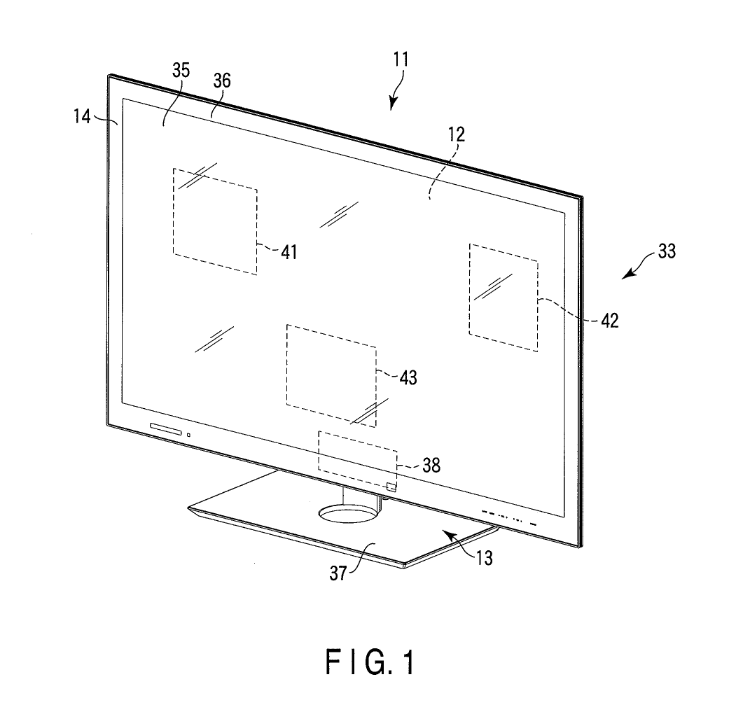

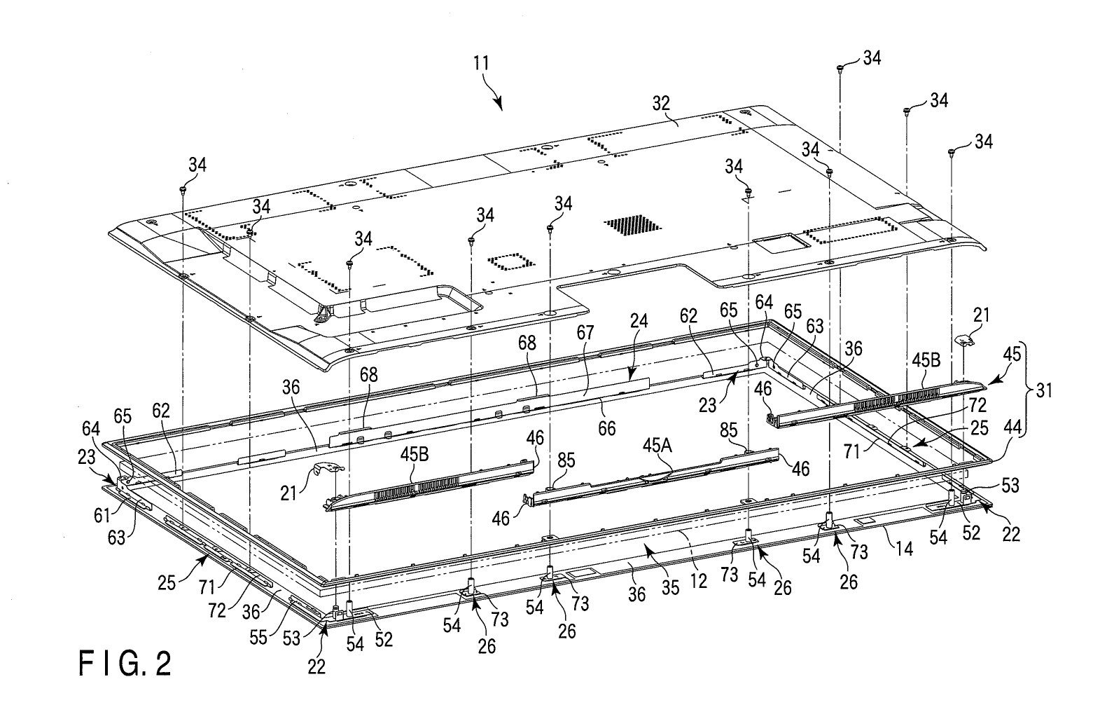

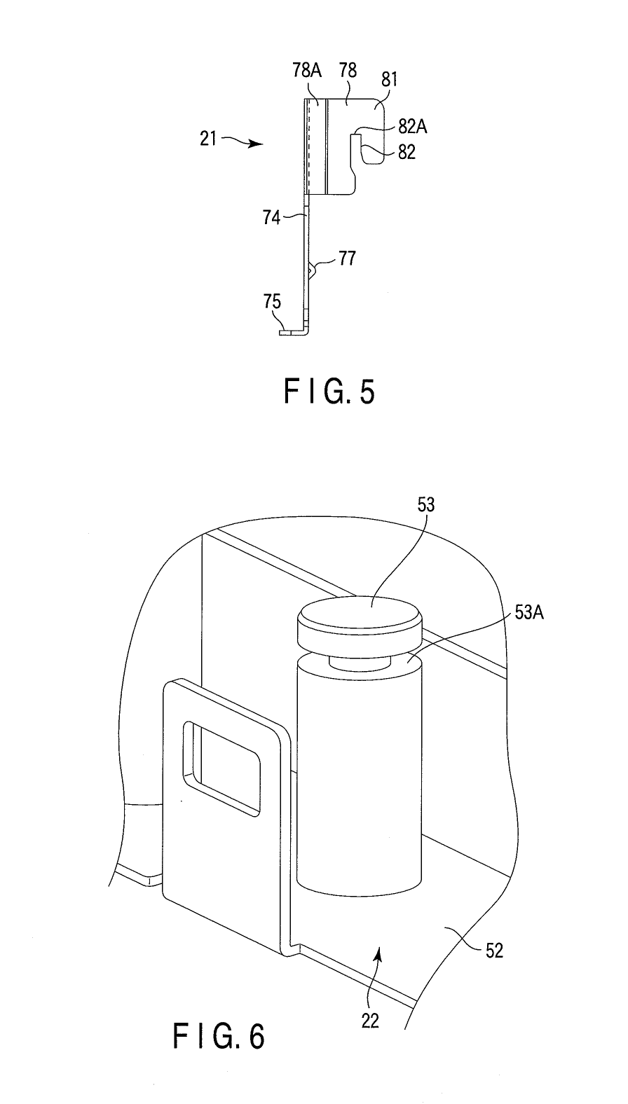

An embodiment of a television, which is an example of the electronic devices, will now be described with reference to FIGS. 1 to 12. As shown in FIG. 1, a television 11 according to this embodiment is a thin display apparatus having a rectangular appearance. As shown in FIGS. 1 and 2, the television 11 comprises a display panel 12, a stand 13 which supports the display panel 12, a flat plate-shaped cover 14 which covers a front surface of the display panel 12, first to six metal fittings 21 to 26 which secure the cover 14 to the display panel 12, a frame unit 31, which is an example of an intermediate member intervened between the cover 14 and the first metal fitting 21, a back cover 32 which covers a back surface of the display panel 12, a control unit 33 which is connected to the display panel 12 and overall controls the entire television 11, and screws 34 which secure a cover 14, a frame unit 31 and the back cover 32.

In this embodiment, the display panel 12 is a liquid crystal panel having a square plate shape. The display panel 12 may be some other type of display panel such as a plasma display panel or an organic EL panel. As shown in FIG. 8, the display panel 12 comprises a front surface 12A, a back surface 12B, a pair of side surfaces 12C which normally cross the front surface 12A and the back surface 12B, and a top surface 12D and a bottom surface 12E which normally cross the front surface 12A and the back surface 12B. The television 11 of this embodiment does not include a frame or the like, which serves as its backbone in its central portion, but the display panel 12 itself serves as a reinforcement member which maintains the upright position of the television. In other words, the display panel 12 and the stand 13 each are an example of the main body portions which give rise to the main portions of the television 11.

As shown in FIGS. 1 and 2, the cover 14 is transparent and has a flat plate shape. In this embodiment, the cover 14 is made of, for example, a glass-made panel, but it may be made of an acryl resin-made panel. The cover 14 comprises an overlaying portion 35 which overlays on the display panel 12 and a margin portion 36 provided in a four-sided circumference of the overlaying portion 35. The margin portion 36 is provided at extruding positions outward from the display panel 12 (the main body portion).

The stand 13 comprises a leg portion 37 and a square-shaped reinforcing plate 38 which connects the leg portion 37 and the display panel 12 to each other. In this embodiment, the stand 13 is set to support the display panel 12 via the reinforcing plate 38, but it is alternatively possible that the stand 13 directly support the display panel 12 without the reinforcing plate 38 intermediating therebetween.

As shown in FIG. 1, the control unit 33 comprises a plurality of printed circuit boards such as a tuner substrate 41, a system substrate 42 and a power circuit board 43. The tuner substrate 41, the system substrate 42 and the power circuit board 43 of the control unit 33 are mounted at predetermined positions respectively on the rear surface of the display panel 12.

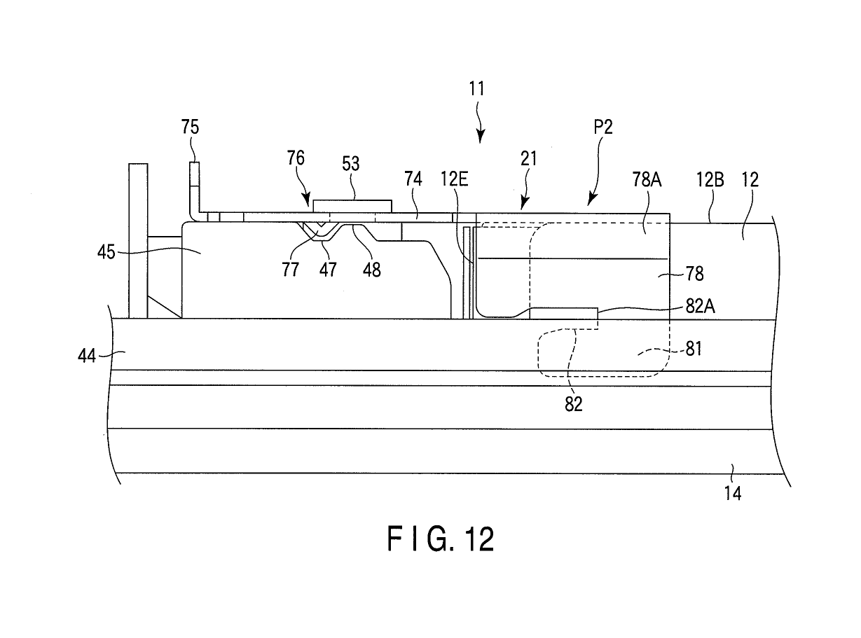

As shown in FIG. 2, the frame unit 31 comprises an edge portion 44 having a square frame shape, and a bottom piece 45 which forms an outer enclosure of the television 11 at the bottom portion thereof. The edge portion 44 and the bottom piece 45 are each formed of a synthetic resin. The bottom piece 45 comprises a first piece 45A disposed in a central portion, and two second pieces 45B provided on lateral both end portions of the television 11. The first piece 45A and the second pieces 45B are assembled together via connector portions 46 provided at respective ends, to form the bottom piece 45 as one unit. The two second pieces 45B are formed to be bilaterally symmetrical to each other. As shown in FIG. 12, each of the second pieces 45B comprises a recess portion 47 into which a protruding portion 77 of the first metal fitting 21, which will be later explained, is fit, and a bank portion 48 provided adjacent to the recess portion 47. The bank portion 48 serves to prevent the protruding portion 77 of the first metal fitting 21 from departing from the recess portion 47 once the protruding portion 77 is fit thereinto.

In this embodiment, the frame unit 31 (intermediating member) is formed of the edge portion 44 and the bottom piece 45, but it is alternatively possible to form the frame unit of a single member.

As shown in FIG. 2, the second metal fittings 22 are provided as a pair, and each of the second metal fitting 22 is disposed on the margin portion 35 of the cover 14 at a portion near a respective corner on the bottom side of the cover 14. As shown in FIGS. 2, 7 and 9, each of the second metal fittings 22 comprises a second adhesion portion (adhesion portion) of a plate having substantially an “L” letter shape, a pin 53 projecting from the second adhesion portion 52, an aligning pin 54 provided on the second adhesion portion 52 and having a screw hole at its distal end, a projecting portion 55 projecting from the second adhesion portion 52 in a direction crossing the cover 14, a flange portion 56 extending from the projecting portion 55 in a direction substantially in parallel with the cover 14, a slit 57 provided in the flange portion 56, and a first edge portion 58 and a second edge portion 59 which define the surrounding of the slit 57. The second adhesion portion 52 is adhered to the cover 14 via, for example, a double-side adhesive tape. The aligning pin 54 extends in a direction crossing the cover 14.

The pin 53 extends in a direction crossing the cover 14. As shown in FIG. 6, the pin 53 comprises a ring-shaped groove portion 53A formed in the vicinity of its distal end portion to recess from its outer circumferential portion.

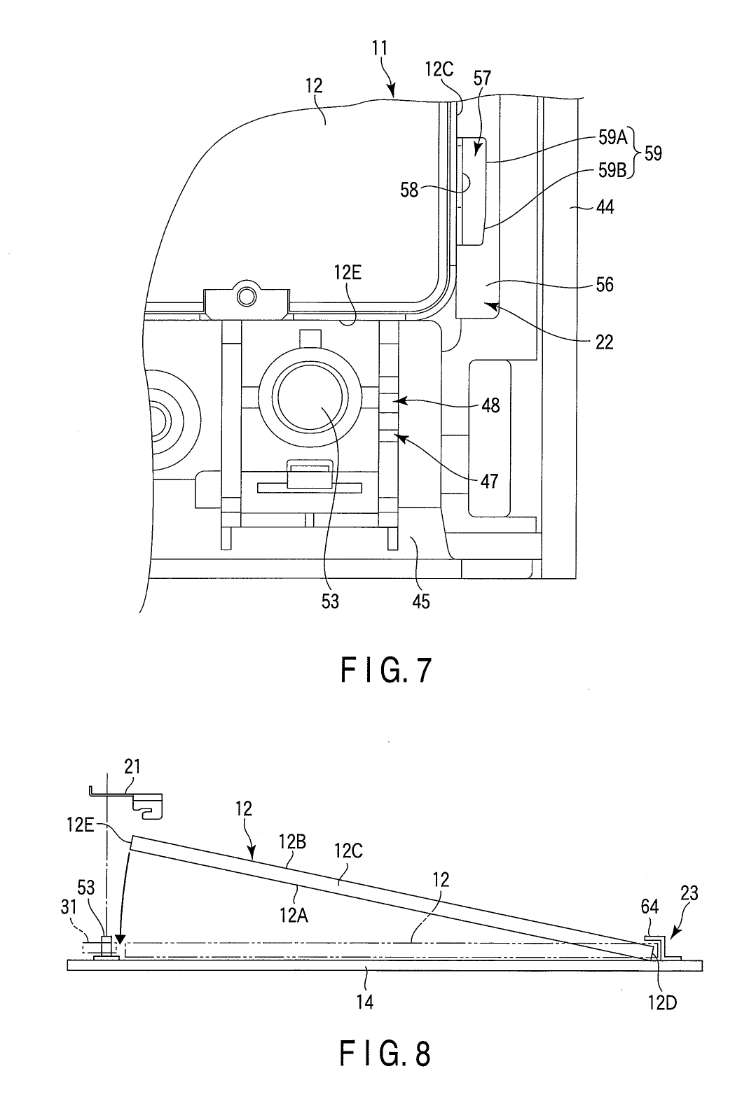

As shown in FIG. 7, the first edge portion 58 defines the surrounding of the slit 57 at a position closer to the display panel 12 as compared to the slit 57. The second edge portion 59 defines the surrounding of the slit 57 at a position further from the display panel 12 as compared to the slit 57. In this embodiment, the first edge portion 58 is set in parallel with the side surfaces 12C of the display panel 12. Of the second edge portion 59, a portion 59A is set in parallel with the side surfaces 12C of the display panel 12, whereas an other portion 59B is set to be oblique with respect to the side surfaces 12C of the display panel 12. With this structure, the slit 57 is set to be substantially oblique with respect to the side surfaces 12C of the display panel 12, and it serves to guide the first metal fitting 21 obliquely with respect to the side surfaces 12C.

As shown in FIG. 2, the third metal fittings 23 are provided as a pair, and each of the third metal fittings 23 is disposed on the margin portion 36 of the cover 14 at a portion near a respective corner on the upper side of the cover 14. Each of the third metal fittings 23 comprises a third adhesion portion 61 adhered to the cover 14 with, for example, a double-sided adhesive tape, a first wall portion 62 which extends from the third adhesion portion 61 in a direction crossing the cover 14 and abuts to the upper surface 12D of the display panel 12, a second wall portion 63 which extends from the third adhesion portion 61 in a direction crossing the cover 14 and abuts to the side surface 12C of the display panel 12, and a first hook portion 64 which extends from the second wall portion 63 in a direction substantially parallel to the cover 14 and abuts to the back surface 12B of the display panel 12. The third connection portion 61 is a plate having substantially an “L” shape.

The first wall portion 62 and the second wall portion 63 each have a small projection 65 for aligning the display panel 12.

As shown in FIG. 2, the fourth metal fitting 24 is disposed on the margin portion 36 of the cover 14 at a portion corresponding to the upper side of the display panel 12. The fourth metal fittings 24 comprises a fourth adhesion portion 66 adhered to the cover 14, a third wall portion 67 which extends from the fourth adhesion portion 66 in a direction crossing the cover 14 and abuts to the upper surface 12D of the display panel 12, and a second hook portion 68 which extends from the third wall portion 67 in a direction substantially parallel to the cover 14 and abuts to the back surface 12B of the display panel 12.

The fifth metal fittings 25 are provided as a pair, and each of the fifth metal fittings 25 is disposed on the margin portion 36 of the cover 14 at a portion corresponding to a respective side surface 12C of the display panel. Each of the fifth metal fittings 25 comprises a fifth adhesion portion 71 adhered to the cover 14 and a forth wall portion 72 which extends from the fifth adhesion portion 71 in a direction crossing the cover 14 and abuts to the side surface 12C of the display panel 12.

There are a plurality of six metal fittings 26. The six metal fittings 26 are disposed to be a part from each other respectively at plurality of positions on the margin portion 36 of the cover 14 corresponding to the lower surface 12E of the display panel 12. Each of the six metal fittings 26 comprises a small piece-like six adhesion portion 73 adhered to the cover 14 with, for example, a double-sided tape, and an aligning pin 54 which extends from the six adhesion portion 73 in a direction crossing the cover 14. The aligning pin 54 comprises a screw hole at its distal end to which a screw 34 is engaged for fastening.

As shown in FIG. 2, the first metal fittings 21 are symmetrically as a pair to correspond to the corner portions of the lower side of the display panel 12. Each of the first metal fittings 21 has a small piece disposed to be separated from the cover 14. The pair of the first metal fittings 21 are formed to be bilaterally symmetrical to each other. The display panel 12 is interposed between the first metal fittings 21 and the cover 14.

As shown in FIGS. 2 to 5 and 9, each of the first metal fittings 21 comprises a metal fitting main body 74 formed to be substantially parallel with the front surface 12A (or the back surface 12B) of the display panel 12, a finger hook portion 75 continuous from the metal fitting main body 74, an opening portion 76 made in the metal fitting main body 74, a protruding portion 77 protruding from the metal fitting main body 74 towards the frame unit 31, which is an intermediating member, a guiding portion 78 continuous from the metal fitting main body 74, a hook portion 81 provided at the tip end of the guiding portion 78 and having an “L” letter shape, and a receiving portion 82 formed within the hook portion 81.

The opening portion 76 comprises a first part 76A having a diameter larger than the diameter of the pin 53 and a second part 76B formed continuous to the first part 76A having a diameter smaller than the diameter of the pin 53. The metal fitting main body 74 defines the surrounds of the first part 76A and the second part 76B of the opening portion 76.

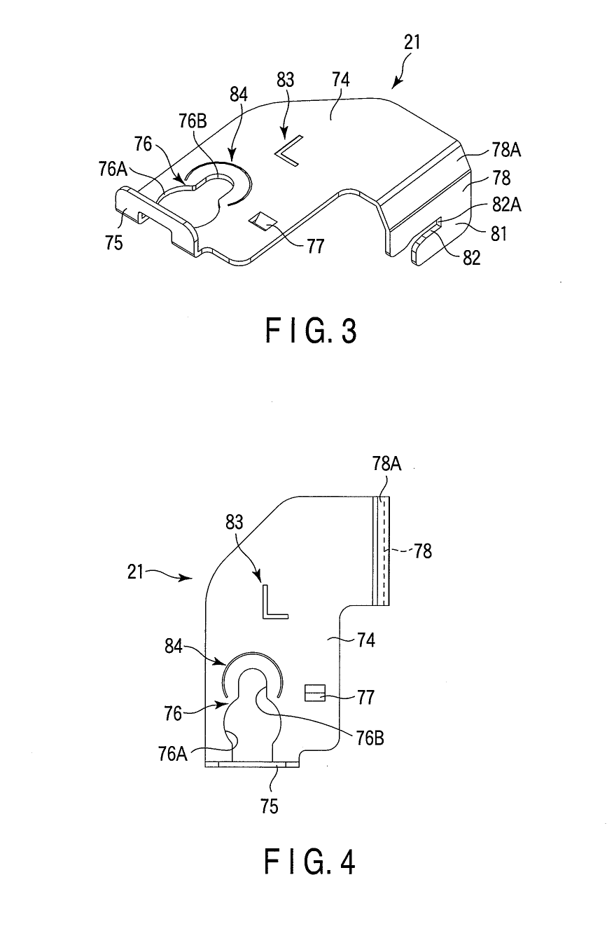

As shown in FIG. 3, for example, an impression 83 of an “L” letter is engraved in the metal fitting main body 74, so as to indicate that the main body 74 is the first metal fitting 21 used on the left side as viewed from the front surface of the television 11. Similarly, an impression 83 of an “R” letter is engraved in the metal fitting main body 74, so as to indicate that the main body 74 is the first metal fitting 21 used on the right side as viewed from the front surface of the television 11. An impression 84 of a curved line is also engraved in each main body 74, which indicates the position of the pin 53 when the respective main body is at the second portion P2.

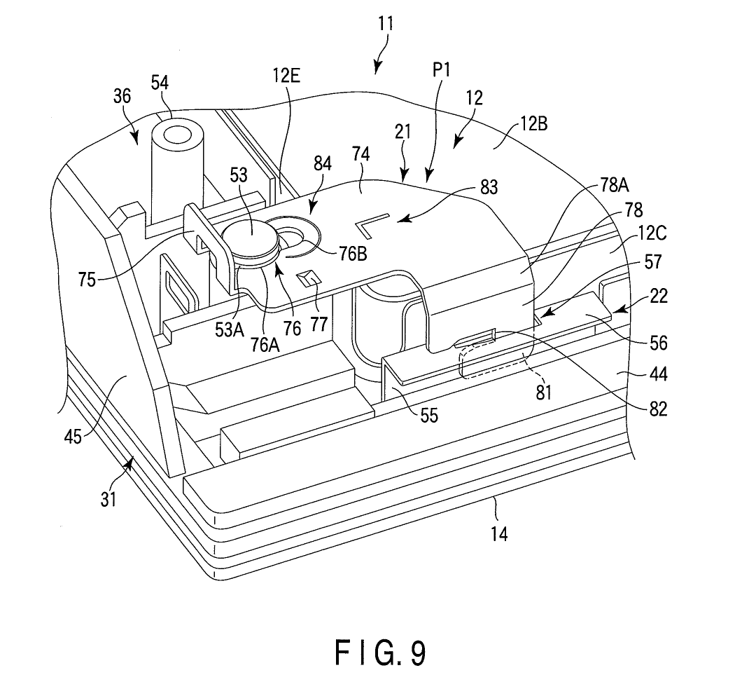

The finger hook portion 75 extends in the direction crossing the main body 74, and with this structure, the operator can place a finger on the portion 75. As shown in FIG. 9, the guiding portion 78 extends substantially in parallel with the side surface 12C of the display panel 12 to be put into the slit 57. The slit 57 of the second metal fitting 22 can guide the movement of the first metal fitting 21 via the guiding portion 78. The guiding portion 78 comprises a connection portion 78A connected to the main body 74, and the connection portion 78A is formed to be oblique with respect to the main body 74. With this structure, the connection portion 78A is set obliquely with respect to the side surface 12C of the display panel 12. The connection portion 78A comprises a contact portion of the guiding portion 78, which is brought into contact with the side surface 12C of the display panel 12.

The hook portion 81 extends substantially in parallel with the side surface 12C of the display panel 12 and projects to the rear side of the flange portion 56. When the first metal fitting 21 is placed at the second portion P2, the hook portion 81 is hooked on the flange portion 56. The opening of the receiving portion 82 becomes wider as the location is further away from its deep end portion 82A. In other words, in the hook portion 81, the tip end, that is, the corner portion on the near end side of the receiving portion 82 is removed.

Further, the opening portion 76 comprises the first part 76A having a diameter larger than the diameter of the pin 53 and the second part 76B formed continuous to the first part 76A. The second part 76B has a diameter smaller than the diameter of the pin 53.

Next, with reference to FIG. 2, etc., the assembling process of the television 11 of this embodiment will now be described. First, the display panel 12 is mounted to the cover 14 which is placed on a workbench. Here, the second to sixth metal fittings 26 are adhered in advance to the margin portion 36 of the cover 14 with, for example, double-sided adhesive tapes. The display panel 12 is mounted as shown in FIG. 8, that is, the upper corner portions of the display panel 12 are inserted to the lower side of the first hook portion 64.

Next, as shown in FIGS. 2 and 8, the edge portion 44 of the frame member 31 is mounted to the margin portion 36 of the cover 14. Then, the bottom pieces 45 are adhered to the edge portion 44 from an upper side. The bottom pieces 45 are fixed by utilizing the through holes 85 made in each of the bottom pieces 45 and the aligning pins 54.

Further, the first metal fitting 21 is mounted to each other bottom pieces 45 from an upper side. During this operation, the pin 53 is put through the first part 76A of the opening portion 76 and the guiding portion 78 and the hook portion 81 are put through the slit 57. At this stage, the first metal fitting 21 is at the first position P1 as shown in FIG. 9. It should be noted that at the first portion P1, the connection portion 78A of the guiding portion 78 is at a position part from the side surface 12C of the display panel 12.

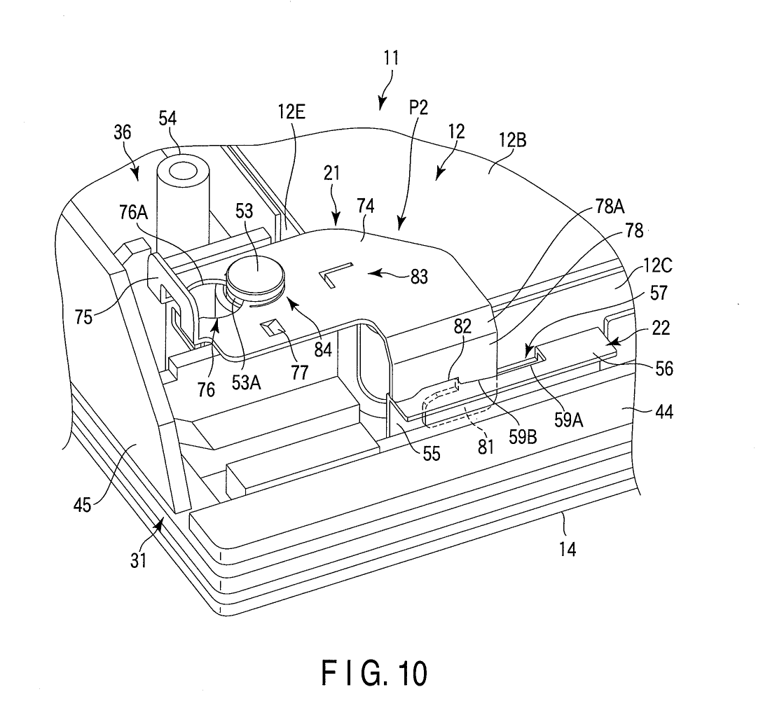

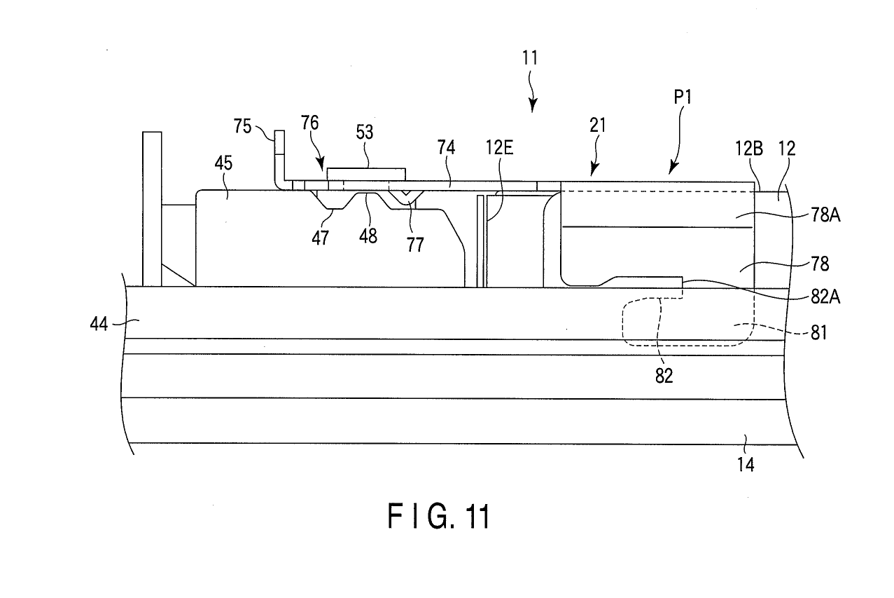

Subsequently, the operator places a finger on the finger hook portion 75 of the first metal fitting 21 and slides the first metal fitting 21 in a direction away from the center of the display panel 12. By this movement, the guiding portion 78 of the first metal fitting 21 moves along the slit 57 from one end of the slit to the other end as shown in FIG. 10. Further, as shown in FIGS. 11 and 12, the protruding portion 77 of the first metal fitting 21 goes over the bank portion 48 provided on the second piece 45B of the bottom piece 45, and fits inside the recess portion 47. At the same time, the pin 53 is put through inside the second portion 76B of the opening portion 76, and the main body 74 of the first metal fitting 21 is fit into the groove portion 53A of the pin 53. In this manner, the first metal fitting 21 moves to the second position P2 as shown in FIG. 10. At the second position P2, the free movement of the first metal fitting 21 is restricted, and thus the display panel 12 and the cover 14 are fixed to each other. Further, at the second position P2, the connection portion 78A of the guiding portion 78 is pressed against the side surface 12C of the display panel 12 to abut thereto. In this manner, the movement of the cover 14 in the direction in parallel to the display panel 12 is restricted.

Further, the reinforcing plate 38 and the leg portion 37 (stand 13) are secured to the display panel 12. After that, the back cover 32 is mounted to the display panel 12 and the cover 14, and the screws 34 are engaged to the aligning pins 54, respectively, over the cover 14. Thus, the assembling process of the television 11 is completed.

According to the first embodiment, the television 11 comprises the display panel 12, the flat plate-shaped cover 14 further comprising the margin portion 36 around its four sides to extrude outward from the display panel 12, and covering the front surface 12A of the display panel 12, the pins 53 each extending from the margin portion 36 in the direction crossing the cover 14 and provided with the groove portion 53A which recesses from its circumference, and the first metal fittings 21 each further comprising the opening portion 76 comprising the first part 76A having a diameter larger than the diameter of the pin 53 and the second part 76B formed continuous to the first part 76A and having a diameter smaller than the diameter of the pin 53, and the main body 74 which defines the surroundings of the opening portion 76, the display panel 12 being interposed between the cover 14 and the first metal fittings 21. Each of the first metal fittings 21 is movable between the first position P1 where the pin 53 is put into the first part 76A, and the second position P2 where the pin 53 is put into the second part 76B and main body 74 is fit into the groove portion 53A.

With this structure, the cover 14 can be secured to the display panel 12 in a simple structure without using screws. In this manner, the number of parts can be reduced.

Further, the television 11 comprises the intermediate member intervened between the cover 14 and the first metal fittings 21. Each of the first metal fittings 21 comprises the protruding portion 77 protruding from the main body 74 towards the intermediate member, and the intermediate member comprises the recess portion 47. When the first metal fitting 21 is at the second position P2, the protruding portion 77 is fit into the recess portion 47. With this structure, it is possible to prevent the first metal fittings 21 from falling off from the respective pins 53, which may occur just in case where the operator unintentionally moves the first metal fittings 21 from the second position P2.

The television 11 comprises the second metal fittings 22 each comprises the adhesion portion adhered to the cover 14, the pin 53 provided in the adhesion portion, the projecting portion 55 projecting from the adhesion portion in the direction crossing the cover 14, and the flange portion 56 extending from the projecting portion 55 in the direction substantially in parallel with the cover 14, and the slit 57 is made in the flange portion 56. Each of the first metal fitting 21 comprises the guiding portion 78 formed continuous from the main body 74 and put into the slit 57, and the slit 57 guides the movement of the first metal fitting 21 via the guiding portion 78.

With the above-described structure, the moving direction of the first metal fitting 21 is regulated by the slit 57 and the guiding portion 78, and thus the first metal fitting 21 can be moved smoothly between the first position P1 and the second position P2.

Further, the slit 57 extends obliquely with respect to the side surface 12C of the display panel 12, and the main body 74 is set substantially in parallel with the front surface 12A of the display panel 12. The guiding portion 78 is set substantially in parallel with the side surface 12C of the display panel 12. The guiding portion 78 is detached from the side surface 12C of the display panel 12 at the first position P1, whereas it abuts to the side surface 12C of the display panel 12 at the second position P2. With this structure, not only the movement of the display panel 12 in its width direction can be restricted, but also the movement of the cover 14 in the direction parallel to the display panel 12 can be restricted by the first metal fittings 21.

The guiding portion 78 comprises the hook portion 81 and the hook portion 81 is hooked on the flange portion 56 when the first metal fitting 21 is at the second position P2. With this structure, the movement of the cover 14 in the thickness direction of the display panel 12 can be restricted not only by the fitting of the main body 74 to the groove portion 53A, but also by means of the hook portion 81. Therefore, the cover 14 and the display panel 12 can be secured to each other more firmly.

The first metal fitting 21 comprises the receiving portion 82 formed within the hook portion 81 and fit with the flange portion 56, and the opening of the receiving portion 82 becomes wider as the location is further away from its deep end portion 82A. With this structure, it is possible to prevent the hook portion 81 from bumping to the edge of the flange portion 56, which may occur when the hook portion 81 is being hooked on the flange portion 56. Thus, the first metal fitting 21 can be moved fro the first position P1 to the second position P2 smoothly.

The first metal fitting 21 comprises the finger hook portion 75 formed continuous to the main body 74. With this structure, when the first metal fitting 21 should be moved between the first position P1 and the second position P2, the operator can place a finger on the finger hook portion 75 and move the fitting. In this manner, the operability of the first metal fitting 21 can be improved.

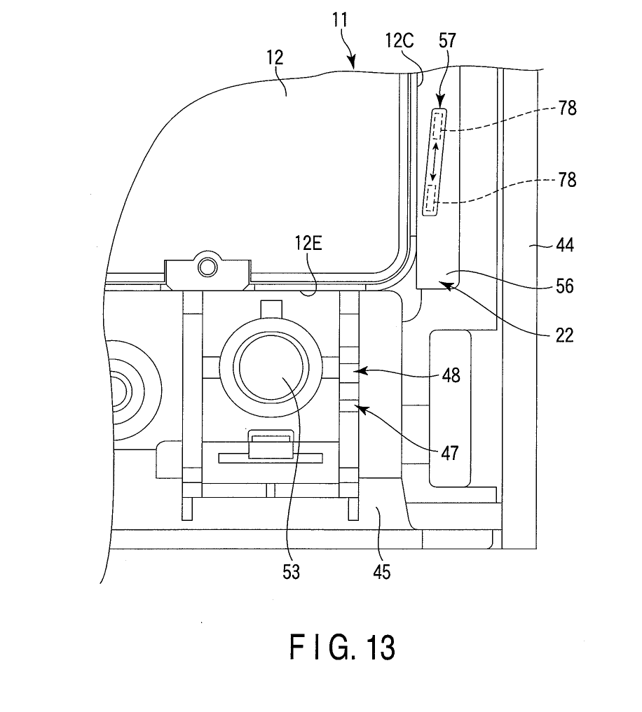

The electronic device is not limited to the television 11 described in the above-provided embodiment, but it can be naturally applied to some other electronic devices such as portable computers, mobile telephones and electronic book readers which electronically display pages of books and images, etc. In the above embodiment, a part of the second edge portion 59 of the slit 57 is set obliquely with respect to the side surface 12C of the display panel 12, but it is alternatively possible to form the slit 57 itself obliquely with respect to the side surface 12C of the display panel 12, as shown in FIG. 13.

Further, the electronic device is not limited directly to the above-described embodiment, but it can be realized while remodifying the structural elements thereof within the scope where the essence thereof remains. Further, various types of embodiments can be achieved by combining or rearranging various structural elements disclosed in the embodiment appropriately. For example, some of the structural elements may be deleted from the entire structure disclosed in the embodiment. Further, structural elements of various versions may be combined together as needed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A television comprising:
a display panel;
a flat plate-shaped cover configured to cover a front surface of the display panel, the cover comprising a margin portion around four sides of the cover that extends outward from the display panel;
a pin extending generally perpendicularly from the margin portion toward the display panel and comprising a groove portion recessed from an outer circumference of the pin;
a first metal fitting comprising
an opening portion comprising a first part having a diameter larger than a diameter of the pin between the outer circumference and a second part adjacent the first part and having a diameter smaller than the diameter of the pin between the outer circumference, and
a fitting main body surrounding at least some of the opening portion, wherein the display panel is interposed between the cover and the first metal fitting, and wherein the first metal fitting is movable between
a first position wherein the first metal fitting is configured to receive the pin in the first part and
a second position wherein the first metal fitting is configured to receive the pin in the second part, such that a portion of the fitting main body contacts the groove portion.

2. The television of claim 1, further comprising:
an intermediate member interposed between the cover and the first metal fitting,
wherein the first metal fitting comprises a protruding portion protruding from the fitting main body towards the intermediate member, and
the intermediate member comprises a recess portion configured to receive the protruding portion when the first metal fitting is at the second position.

3. The television of claim 2, further comprising:
a second metal fitting further comprising
an adhesion portion adhered to the cover, wherein the pin extends from the adhesion portion,
a projecting portion projecting generally perpendicularly from the adhesion portion in a direction opposite the cover, and
a flange portion extending from the projecting portion in a direction substantially parallel to the cover, the flange portion comprising a slit,
wherein the first metal fitting comprises a guiding portion adjacent the fitting main body and the slit is configured to receive the guiding portion, and
wherein the slit is configured to guide movement of the first metal fitting via the guiding portion.

4. The television of claim 3, wherein
the slit extends obliquely with respect to a side surface of the display panel,
the fitting main body is substantially parallel to a front surface of the display panel,
the guiding portion is substantially parallel to the side surface of the display panel, and
the guiding portion is configured to be detached from the side surface of the display panel at the first position, and configured to abut the side surface of the display panel at the second position.

5. The television of claim 4, wherein
the guiding portion comprises a first hook portion and the first hook portion is configured to be hooked on the flange portion when the first metal fitting is at the second position.

6. The television of claim 5, wherein
the first metal fitting comprises a receiving portion formed within the first hook portion and configured to receive the flange portion, wherein one end of the receiving portion is wider than an opposite end of the receiving portion.

7. The television of claim 6, wherein
the first metal fitting comprises a second hook portion adjacent the fitting main body.

8. An electronic device comprising:
a main body portion;
a flat plate-shaped cover configured to cover a front surface of the main body portion, the cover comprising a margin portion around four sides of the cover;
a pin extending from the margin portion and comprising a groove portion recessed from an outer circumference of the pin, and
a first metal fitting comprising
an opening portion comprising a first part having a diameter larger than a diameter of the pin between the outer circumference and a second part adjacent the first part and having a diameter smaller than the diameter of the pin between the outer circumference, and
a fitting main body surrounding at least some of the opening portion,
wherein the main body portion is interposed between the cover and the first metal fitting, and
wherein the first metal fitting is movable between
a first position wherein the first metal fitting is configured to receive the pin in the first part and
a second position wherein the first metal fitting is configured to receive the pin in the second part, such that a portion of the fitting main body contacts the groove portion.

9. The electronic device of claim 8, further comprising:
an intermediate member interposed between the cover and the first metal fitting,
wherein the first metal fitting comprises a protruding portion protruding from the fitting main body towards the intermediate member, and
the intermediate member comprises a recess portion configured to receive the protruding portion when the first metal fitting is at the second position.

10. The electronic device of claim 9, further comprising:
a second metal fitting further comprising
an adhesion portion adhered to the cover, wherein the pin extends from the adhesion portion,
a projecting portion projecting generally perpendicularly from the adhesion portion in a direction opposite the cover, and
a flange portion extending from the projecting portion in a direction substantially parallel to the cover, the flange portion comprising a slit,
wherein the first metal fitting comprises a guiding portion adjacent the fitting main body and the slit is configured to receive the guiding portion, and
wherein the slit is configured to guide movement of the first metal fitting via the guiding portion.

11. The electronic device of claim 10, wherein
the slit extends obliquely with respect to a side surface of the display panel,
the fitting main body is substantially parallel to a front surface of the display panel,
the guiding portion is substantially parallel to the side surface of the display panel, and
the guiding portion is configured to be detached from the side surface of the display panel at the first position, and configured to abut the side surface of the display panel at the second position.

12. The electronic device of claim 11, wherein
the guiding portion comprises a first hook portion and the first hook portion is configured to be hooked on the flange portion when the first metal fitting is at the second position.

13. The electronic device of claim 12, wherein
the first metal fitting comprises a receiving portion formed within the first hook portion and configured to receive the flange portion, wherein one end of the receiving portion is wider than an opposite end of the receiving portion.

14. The electronic device of claim 13, wherein
the first metal fitting comprises a second hook portion adjacent the fitting main body.
